(19) United States
(12) Patent Application Publication
(10) Pub. No.: US 2005/0043172 A1
(43) Pub. Date: Feb. 24, 2005

(54) Bromine-impregnated activated carbon and process for producing the same

(76) Inventors: Masanori Tsuji, Osaka (JP); Masanori Yamanaka, Osaka (JP); Tsuyoshi Yoshidome, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/915,408

(22) Filed: Aug. 11, 2004

(30) Foreign Application Priority Data
Aug. 12, 2003 (JP) 2003-292437

(51) Int. Cl. C01B 31/08

(52) U.S. Cl. 502/417

(57) ABSTRACT

Bromine-impregnated activated carbon which is obtainable by being impregnated with bromine in an amount of 3 to 20% by weight into an activated carbon which has 44.0 to 60.0% by weight of a water retention ratio and less than 0.01% by weight of a chloride content can effectively remove alkyl sulfides from the gas containing sulfur compounds such as hydrogen sulfide, mercaptans and alkyl sulfides at a low concentration.

### TECHNICAL FIELD

The present invention relates to bromine-impregnated activated carbon, and a process for producing the same. More particularly, it related to the bromine-impregnated activated carbon which is useful for the removal of alkyl sulfides effectively from gas containing the alkyl sulfides at a low concentration, and a process for producing the same.

### BACKGROUND ART

Sulfur compounds such as hydrogen sulfide, mercaptans and alkyl sulfides are contained in exhaust gas from sewage disposal plants, night soil treatment plants, waste disposal plants and others, or process gas or exhaust gas from chemical factories for petroleum refining, petroleum chemistry, pulp and paper industries and others, food factories and so on.

Hitherto, various methods have been known as methods for removing the sulfur compounds from such gases, examples thereof including. alkali absorbing, wet oxidizing, ozone oxidizing, activated carbon adsorbing, and burning methods.

However, these conventional methods do not make it possible to remove the alkyl sulfides such as dimethyl sulfide and dimethyl disulfide, which has been designated as special malodorous substances, sufficiently or satisfactorily although the methods can remove many other sulfur compounds.

It has been reported that the activated carbon adsorbing method using bromine-impregnated activated carbon, which is obtained by being impregnated with bromine, can remove dimethyl sulfide and dimethyl disulfide by chemical adsorption unlike physical adsorption by ordinal activated carbon (JP-A-54-132470, JP-B-55-20732, U.S. Pat. No. 4256728 and U.S. Pat. No. 6514907).

However, the quality of the bromine-impregnated activated carbon is uneven due to, for instance, the kind of the activated carbons and the amount of the impregnated bromine. Under these circumstances, alkyl sulfides such as dimethyl sulfide and dimethyl disulfide cannot be necessarily removed satisfactorily.

### DISCLOSURE OF THE INVENTION

In the course of research to solve the above-mentioned problems, components, natures, physical properties and so on of various kinds of bromine-impregnated activated carbons have been investigated, it has been eventually found that there is a high correlation between the water retention ratio of activated carbon to be caused to be impregnated with bromine beforehand, an amount of impregnated bromine in the activated carbon and an amount of a chloride content in the activated carbon with adsorption effect of offensive odor substances such as dimethyl sulfide and dimethyl disulfide recognized as special malodorous substances. In addition, it has been found that the adsorbing performance of bromine-impregnated activated carbon is affected by the amount of impurities contained in the activated carbon, in particular, chlorides contained in the activated carbon. Thus, the present invention has been made on the basis of these new findings.

That is, the present invention is:
(1) Bromine-impregnated activated carbon which is obtainable by causing the activated carbon having 44.0 to 60.0% by weight of a water retention ratio and less than 0.01% by weight of a chloride content to be impregnated with bromine in an amount 3 to 20% by weight relative to the activated carbon
(2) The bromine-impregnated activated carbon according to (1), wherein the activated carbon to be impregnated with bromine has 44.0 to 56.0% by weight of a water retention ratio and less than 0.005% by weight of a chloride content.
(3) The bromine-impregnated activated carbon according to (1), wherein the activated carbon to be impregnated with bromine has 0.50 to 1.20 ml/g of pore volume.
(4) The bromine-impregnated activated carbon according to (1), which is for removing alkyl sulfides.
(5) A process for producing bromine-impregnated activated carbon which comprises washing an activated carbon having a water retention ratio of 44.0 to 60.0% by weight with water or ion exchange water, or heating the active carbon at 500 to 1100° C. in the absence of oxygen, thereby producing the activated carbon having less than 0.01% by weight of chloride content; and causing the obtained activated carbon to be impregnated with bromine in an amount of 3 to 20% by weight into the resultant activated carbon.

The “water retention ratio” referred to in the present invention can be determined by the following steps:

Water is added to dry activated carbon and sufficiently infiltrated into the activated carbon. Then the activated carbon is dehydrated by, for example, centrifugation, whereby the water between particles of activated carbon is removed but the water in pores of the activated carbon is not removed. The water retention ratio is obtained by calculating the content by weight percentage of the water retained in the activated carbon after the dehydration.

The water retention ratio has a high correlation with the total volume of micro pores which contribute directly to adsorption of the compound and macro pores which function as passages of the compound from the surface to the inner micro pores.

“Chloride content” is determined by the following steps:

After the activated carbon is boiled in water, chloride ions (C1⁻) contained in the water are quantitatively analyzed by ion chromatography; and the chloride content is shown by the weight percentage relative to the weight of the activated carbon.

The chloride is an element belongs to halogen, to which bromine is also belonged. If the chloride is present previously to bromine inside pores of the activated carbon, the performance for removing alkyl sulfides such as dimethyl sulfide falls down, because chloride has no ability to remove the alkyl sulfides.

One of the objects of the present invention is to provide the bromine impregnated activated carbon which is obtainable by causing the activated carbon having 44.0 to 60.0% by weight of a water retention ratio and less than 0.01% by weight of a chloride content to be impregnated with bromine in an amount 3 to 20% by weight relative to the activated carbon, showing high performance for removing the alky sulfides.

Another object of the present invention is to provide a process for producing the above-mentioned bromine-impregnated activated carbon, wherein raw activated carbon is washed several times with water or ion exchange water or washed with boiling water, or is treated at 500 to 1100° C., preferably at 700 to 900° C. in the absence of oxygen, thereby reducing chloride contents; and the resultant activated carbon is caused to be impregnated with bromine.

The activated carbon having a pore volume of about 0.50 to 1.20 ml/g preferably 0.55 to 0.90 ml/g for producing the bromine-impregnated activated carbon of the present invention may be produced from raw materials for an activated carbon, for example, plant-based material or fossil material such as wood, wood meal, coconut shell, byproducts at the time of producing pulp, bagasse, syrup waste, peat, wood coal, brown coal, bituminous coal, free-burning coal, smokeless coal, petroleum-distilled residue components, petroleum pitch, cokes or coal tar, a variety of synthetic resin such as phenol resin, vinyl chloride resin, vinyl acetate resin, melamine resin, urea resin, resorcinol resin or polyamide resin, a synthetic rubber such as polybutylene, polybutadiene or polychloroprene, a synthetic wood, or a synthetic pulp by known processes.

The shape thereof may be any shape, such as a spherical, columnar, crushed, powdery, granular, fibrous, or honeycomb shape.

The water retention ratio of the raw activated carbon of the present invention is usually from 44.0 to 60.0% by weight, more preferably from 44.0 to 56.0% by weight, even more preferably from 46.0 to 52.0% by weight. A high correlation is present between the water retention ratio of the raw activated carbon and the performance for removing alkyl sulfides. As the raw activated carbon has a higher water retention ratio, the raw activated carbon is more preferable.

In the case that the water retention ratio of the activated carbon is higher than 60.0% by weight, the packing density of the activated carbon becomes low and the activated carbon becomes brittle.

Commercially available activated carbon usually has a water retention ratio of not more than 44.0% by weight. In order to obtain an activated carbon having the water retention ratio of 44.0 to 60.0% by weight, known processes for activating carbon may be applied while making the activation degree thereof higher or deeply. For example, there is a method of putting activated carbon in a furnace heated at 900 to 1000° C. to activate the activated carbon more deeply with water vapor, a method of using, as the starting material of activated carbon, a coal having a low carbonization degree, such as brown coal, bituminous coal or free-burning coal, and activating the coal with water vapor, or some other method. Of course, in order to obtain activated carbon having a high water retention ratio, production processes other than the water vapor activation in the high temperature atmosphere or the starting material selection can be used. In the present invention, in general, activation of the activated carbons is somewhat excessively performed, the water retention ratios of the resultant activated carbon species are measured, and then species suitable for the present invention are selected and used.

The content of chlorides by percentage in the bromine-impregnated activated carbon is less than 0.01% by weight, preferably less than 0.005% by weight.

The impregnated amount of bromine, defined in connection with the bromine-impregnated activated carbon of the present invention, is usually from 3 to 20% by weight, preferably from 3 to 12% by weight, more preferably from 3 to 10% by weight. In the bromine-impregnated activated carbon of the present invention, dimethyl sulfide and dimethyl disulfide are removed by catalytic oxidization action of bromine. However, chlorides do not have such action. If chlorides are present previously inside of the activated carbon, the chlorides hinder introduction of bromine into the activated carbon. It is therefore preferable that the amount of the chlorides in the raw activated carbon is as small as possible.

In order to set the chloride content in the carrier activated carbon to 0.01% or less by weight before the activated carbon is caused to be impregnated with bromine, the raw material may with water or ion exchange water, or a raw material may be heated at 500 to 1100° C., preferably at 700 to 900° C. in the absence of oxygen.

The washing manner using water or ion exchange water may be conducted by immersing raw activated carbon into water or ion exchange water at about 30 to 80° C., preferably 40 to 70° C. for a given time, and stirring the system by air bubbling and/or stirring the system while introducing water vapor into the system from the lower portion thereof. A manner of supplying water or ion exchange water into the system may be continuous or intermittent while stirring raw activated carbon. Such a treatment may be conducted one time, or repeated two or more times.

The chloride-content reducing manner by thermal treatment belongs to a kind of high-temperature thermolysis. The high-temperature thermolysis is a manner of treating raw activated carbon at a high temperature in an oxygen-free inert gas such as nitrogen or argon gas or in vacuum to decompose chlorides thermally. As to the thermal treatment, a higher temperature gives a higher efficiency. However, in some raw activated carbon, their pores are broken at a temperature over about 1200° C.; therefore, the temperature of the treatment is suitably from about 500 to 1100° C., preferably from about 700 to 900° C. The period for the treatment can be appropriately adjusted in accordance with the amount of the raw activated carbon to be treated, or other factors, and is suitably from, for example, about 0.1 to 10 hours. The activated carbon may be subjected to the above-mentioned thermal treatment after the activated carbon is washed with water or ion exchange water.

The impregnation of the activated carbon with bromine can be carried out in a known manner in itself. Examples thereof include the gas-phase impregnation manner, wherein carrier gas containing bromine is brought into contact with the activated carbon subjected to the thermal treatment; the liquid-phase impregnation manner, wherein the treated activated carbon is immersed into bromine water; and a manner of spraying liquid bromine directly onto the treated activated carbon to cause the activated carbon to be impregnated with bromine.

In the gas-phase impregnating manner, for example, air, nitrogen gas or the like is used as carrier gas, the temperature of the bed is adjusted to about 150° C. or less, preferably about 80° C. or less, and a fluid bed, moving bed or spray bed of the activated carbon or some other means is used to conduct gas-phase adsorption continuously. In this manner, it is preferable that bromine-containing gas is circulated to cause the activated carbon to be impregnated with bromine and subsequently only the carrier gas is introduced to purge bromine gas which is not absorbed.

In the liquid-phase impregnating manner, an activated carbon is immersed in bromine water having 1 to 5 weight % of a bromine for 1 to 10 hours, or an activated carbon is contacted with bromine water in a fluid bed, moving bed, fixed bed or spray bed, thereby causing the activated carbon to be impregnated with bromine. Subsequently the activated carbon is separated from the bromine water by filtration and dried. The temperature at this time is preferably about 80° C. or less, more preferably about 50° C. or less.

The manner of causing the activated carbon to be impregnated with bromine is carried out by spraying the liquid bromine, bromine water, or the like on the treated activated carbon while stirring the activated carbon and, if necessary, drying the activated carbon.

The method of adsorbing or removing alkyl sulfides, in particular, dimethyl sulfide and dimethyl disulfide from gas containing these alkyl sulfides with the bromine-impregnated activated carbon of the present invention may be, for example, a method of contacting the gas with the bromine-impregnated activated carbon by a known manner such as a fixed bed, moving bed, fluid bed, slurry type, or batch type contact with stirring. The contact time can be suitably adjusted in accordance with the concentration of the alkyl sulfides, the grain or pellet size of the bromine-impregnated activated carbon, the contact manner thereof, or other factors, and is usually from 0.1 second to 1 minute, for example, at a temperature of about 50° C. or less.

### EFFECTS OF THE INVENTION

The bromine-impregnated activated carbon of the present invention improves remarkably the performance for adsorbing alkyl sulfides compared with conventional bromine-impregnated activated carbons, and further provides consistent performance for removing the alkyl sulfides over a long period of time.

### BEST MODES FOR CARRYING OUT THE INVENTION

The present invention is more specifically described hereinafter, giving working examples and test examples.

### EXAMPLE 1

(1) Preparation of Activated Carbons (AC) Having Equivalent Chloride Contents and Different Water Retention Ratios

Every 200 g of carbonaceous material was activated in a tubular furnace at 900° C. with water vapor flow at 3 ml/minute while the duration for the activation was adjusted to have given water retention ratios. The activated carbons thus obtained were treated with 1000 g of 5% hydrochloric acid for 30 under reflux and then washed under stirring with upward counter flow of ion exchanged water (60° C.), the amount thereof being 100 times as large as the activated carbons, whereby the activated carbons having equivalent chloride contents and different water retention ratios as shown in Table 1 were obtained.

The water retention ratio, chloride content and pore volume of the activated carbons were determined by the following methods.

Method for Measuring the Water Retention Ratio of Activated Carbon

1. An activated carbon sample is dried in an electrical drier at 120° C. for 3 hours, then cooled to room temperature in a desiccator and 50 g of the activated carbon is weighed and put into a 500 ml conical flask.

2. To the flask is added 200 ml of purified water, and the flask is shaken with a shaker at 50° C. for 20 minutes.

3. The activated carbon is put in a nylon mesh bag, and then dehydrated with a dehydrator for 1 minute.

4. The weight We (g) thereof after the dehydration is measured.

5. The water retention ratio is calculated according to the following equation:
Water retention ratio (%)=(We−50)÷We×100.
Determination of the Chloride Ion Content in the Activated Carbons

Chloride content in the activated carbon is measured according to JIS K 1474.

About 3 g of activated carbon was weighed accurately and put in 100 ml of water, boiled for about 5 minutes, filtered after cooling to obtained filtrate. The amount of chloride ion in the filtrate is measured by chromatography and the chloride content in the activated carbon is calculated from the amount of the chloride ion.

Method for Measuring the Pore Volume of Each of the Activated Carbons

The pore volume was measured by the CI method using a pore distribution measuring apparatus, ASAP 2400 (N₂ adsorption method) manufactured by Shimadzu Corp.

(2) Preparation of Activated Carbons Having Equivalent Water Retention Ratios and Different Chloride Contents

Every 200 g of carbonaceous material was activated in a tubular furnace at 900° C. with water vapor flow at 3 ml/minute while the duration for the activation was adjusted to have given water retention ratios. The activated carbons thus obtained were treated with 1000 g of 5% hydrochloric acid for 30 under reflux and were washed under stirring with upward counter flow of ion exchanged water (60° C.), the amount thereof being 20 to 100 times as large as the activated carbons, whereby the activated carbons having equivalent water retention ratios and different chloride contents as shown in Table 2 were obtained.

(3) Activated Carbon Having Higher Water Retention Ratio

Under the same conditions as those in Example 1 (2) except a longer activation period of time has been adopted, the activated carbon having higher water retention ratio was prepared as shown in Table 2.

### EXAMPLE 2

Preparation of Bromine-Impregnated Activated Carbons

The activated carbons obtained in Example 1 were dried at 115° C. in an electrical drier for 3 hours, then cooled to room temperature in a desiccator, and the predetermined amount of each of them was weighed. Then, each of the samples was put into a 1-liter conical glass flask. On an activated carbon layer made flat was put about 3 g of silica wool, and then the given amount of bromine of the best quality reagent was dropped onto the layer. The flask was shaken to cause the activated carbon sample to adsorb vaporized bromine gas. Thus, the bromine-impregnated activated carbons A to P were prepared. All the activated carbon thus obtained had sufficient mechanical strength for adsorbing operation.

The amount of impregnated-bromine in the activated carbons was calculated from an increase in the weight of the activated carbon at the time when the sample was taken out after the whole of bromine was impregnated in the activated carbon so that the inside of the flask got clear and colorless. The results were shown in Tables 1 and 2.

### TEST EXAMPLE 1

Measurement of the Performance for Adsorbing Dimethyl Sulfide

Each of the bromine-impregnated activated carbons obtained in Example 3 was pulverized and the resultant particles were put through sieves having 16 to 22 meshes. A glass column having an inside diameter of 15.6 mm was filled with the pulverized activated carbon to have a layer height of 100 mm (19.1 ml). Air containing 3 ppm of dimethyl sulfide and having a relative humidity of 80% was introduced in the column at 25° C. at a flow rate of 40 cm/sec. The resultant activated carbon particles had sufficient mechanical strength. A gas chromatographic meter equipped with an FPD detector was used to measure the gas concentration (Co) of dimethyl sulfide at an inlet of each of the activated carbon layer and the gas concentration (C) of the same gas at an outlet thereof with the passage of time, and the time when the break through (Break-through time) ratio C/Co of each of the samples turned to 0.05 were recorded.

The results were shown in Tables 1 and 2.

TABLE 1

| | Sample | | | | | | | |
|---|---|---|---|---|---|---|---|---|
| | A | B | C | D | E | F | G | H |
| Raw material | Coal | Coal | Coconut | Coal | Coal | Coconut | Coal | Coconut |
| for AC | | | shell | | | shell | | shell |
| Shape | 4 mm Pellet | 4 mm Pellet | 4 mm Pellet | 4 mm Pellet | 4 mm Pellet | 4 mm Pellet | 4 mm Pellet | 4 mm Pellet |
| Amount of water | 100 | 100 | 100 | 100 | 100 | 100 | 100 | 100 |
| for washing AC (time) | | | | | | | | |
| Water retention | 42.9 | 44.6 | 45.5 | 48.8 | 46.2 | 46.3 | 59.8 | 53.2 |
| ratio (wt %) | | | | | | | | |
| Chloride content (wt %) | 0.0006 | 0.0008 | 0.0005 | 0.0006 | 0.0007 | 0.0005 | 0.0006 | 0.0006 |
| Pore volume (ml/g) | 0.45 | 0.51 | 0.60 | 0.72 | 0.65 | 0.62 | 0.93 | 0.92 |
| Amount of | 9.3 | 9.4 | 9.4 | 9.3 | 2.1 | 3.1 | 14.2 | 19 |
| impregnated bromine (wt %) | | | | | | | | |
| Break-through | 230 | 415 | 542 | 937 | 181 | 403 | 952 | 987 |
| time (hr) | | | | | | | | |

TABLE 2

| | Sample | | | | | | | |
|---|---|---|---|---|---|---|---|---|
| | I | J | K | L | M | N | O | P |
| Raw material | Coconut | Coal | Coconut | Coal | Coconut | Coal | Coal | Coconut |
| for AC | shell | | shell | | shell | | | shell |
| Shape | 4 mm Pellet | 4 mm Pellet | 4 mm Pellet | 4 mm Pellet | 4 mm Pellet | 4 mm Pellet | 4 mm Pellet | 4 mm Pellet |
| Amount of water | 16 | 24 | 44 | 100 | 34 | 56 | 100 | 100 |
| for washing AC (time) | | | | | | | | |
| Water retention | 46.4 | 46.4 | 46.5 | 46.6 | 46.1 | 45.3 | 46.5 | 63 |
| ratio (wt %) | | | | | | | | |
| Chloride content (wt %) | 0.08 | 0.06 | 0.009 | 0.0008 | 0.03 | 0.004 | 0.0006 | 0.001 |
| Pore volume (ml/g) | 0.62 | 0.65 | 0.62 | 0.65 | 0.62 | 0.58 | 0.66 | 1.3 |
| Amount of | 9.4 | 9.3 | 9.3 | 9.4 | 9.1 | 9.3 | 25.0 | 16.5 |
| impregnated bromine (wt %) | | | | | | | | |
| Break-through | 217 | 250 | 451 | 662 | 280 | 536 | 884 | 272 |
| time (hr) | | | | | | | | |

As is evident from the results shown in Table 1 and Table 2, the bromine-impregnated activated carbon samples (B, C, D, F, G, H, K, L and N) obtained from activated carbons having a water retention ratio in the range of 44.0 to 60.0% and a chloride content by weight % of less than 0.01%, and the activated carbons have the amount of impregnated-bromine of 3 to 20% exhibited high performance for removing dimethyl sulfide.

On the other hand, the activated carbons (A, E I, J, M and P) obtained from activated carbons having 44.0% by weight or less of a water retention ratio or more than 0.01% by weight of a chloride content or the activated carbons have the amount of impregnated-bromine outside the scope less than 3% did not exhibit sufficient performance for removing dimethyl sulfide.

The activated carbon (O) showed high performance of adsorbing dimethyl sulfide, but the gas at the outlet of the apparatus smelt of bromine through the test period.

[Industrial Applicability]

Exhaust gas from sewage disposal plants, night soil treatment plants, waste disposal plants and others, or process gas or exhaust gas from chemical factories for petroleum refining, petroleum chemistry, pulp & paper and others, food factories, and other factories contains sulfur compounds such as hydrogen sulfide, mercaptans, and alkyl sulfides. The bromine-impregnated activated carbon of the present invention is used effectively and over a long term for removing alkyl sulfides from the gas generated in these cites or facilities.

1. Bromine-impregnated activated carbon which is obtainable by causing the activated carbon having 44.0 to 60.0% by weight of a water retention ratio and less than 0.01% by weight of a chloride content to be impregnated with bromine in an amount 3 to 20% by weight relative to the activated carbon.

2. The bromine-impregnated activated carbon according to claim 1, wherein the activated carbon has 44.0 to 56.0% by weight of a water retention ratio and less than 0.005% by weight of a chloride content.

3. The bromine-impregnated activated carbon according to claim 1, wherein the activated carbon to be impregnated with bromine has 0.50 to 1.20 ml/g of pore volume.

4. The bromine-impregnated activated carbon according to claim 1, which is for removing alkyl sulfides.

5. A process for producing bromine-impregnated activated carbon which comprises washing an activated carbon having 44.0 to 60.0% by weight of a water retention ratio with water or ion exchange water, or heating the active carbon at 500 to 1100° C. in the absence of oxygen, thereby producing the activated carbon having less than 0.01% by weight of chloride content; and causing the resulting activated carbon to be impregnated with bromine in an amount of 3 to 20% by weight relative to the activated carbon.
